(19) United States
(12) Patent Application Publication
(10) Pub. No.: US 2017/0146784 A1
(43) Pub. Date: May 25, 2017

(54) Compact Microscope Module

(71) Applicants: Jeffrey William Schmidt, Poway, CA (US); Veli-Matti Maatta, Escondido, CA (US)

(72) Inventors: Jeffrey William Schmidt, Poway, CA (US); Veli-Matti Maatta, Escondido, CA (US)

(21) Appl. No.: 14/946,697

(22) Filed: Nov. 19, 2015

(51) Int. Cl. G02B 21/36; G02B 21/26; G02B 21/02; G02B 21/00; G02B 21/04; G02B 21/06

(52) U.S. Cl. CPC G02B 21/361; G02B 21/04; G02B 21/06; G02B 21/025; G02B 21/368; G02B 21/0008; G02B 21/26; G02B 21/365

(57) ABSTRACT

A microscope module for use with a modular user device is described. The microscope module contains a processor, a camera sensor communicated to the first processor, one or more data points configured to transmit data from the camera sensor to the modular user device, a microscope lens, a plurality of mirrors operative to reflect an image from the microscope lens toward the camera sensor in a folded path, a stage which is configured to load a specimen to be visualized, and an adjusting mechanism which adjusts the position of the stage to adjust an optical path distance.

### BACKGROUND

Field of the Technology

Elements of the present disclosure relate generally to the field of microscopy, and more specifically, but not by way of limitation, to compact microscope modules for modular user devices, namely CPC classes G02B 21/00, and G02B 21/0008.

Description of the Prior Art

Telemedicine has numerous applications in developed and developing countries. Users of telemedicine devices require compact and inexpensive medical devices for use in remote areas. There is a need for medical devices which can attach to devices that users already own, such as smartphones or other portable user devices.

### BRIEF SUMMARY

The following description includes apparatuses and methods that embody elements of the disclosure. Numerous specific details are set forth to provide an overview and understanding of various embodiments of the invention. However, it will be evident to those skilled in the art that embodiments of the invention may be practiced without the specific details listed. In general, well-known structures, methods, and techniques are not necessary described in detail.

Many portable microscopes today require a power source, so they cannot be used in remote areas. Moreover, many portable microscopes which transmit image data to a portable user device (e.g., a cellphone) are required to use the camera sensor and lens embedded within the user device. Such camera sensors and lenses may not be tailored for microscopy, and may therefore decrease image quality. Embodiments of the present invention allow for a portable microscope module which fits into a modular phone, containing a microscope lens system as well as an adjustable sample stage.

Moreover, current portable microscopy systems are not suited for the size constraints of a modular user device. For example, a module may have to be smaller than 1″ by 1″ by 2″ to fit within a modular user device. In another example, a microscope module may have to be smaller than 2″ by 2″ by 2″. In yet another example, the microscope module may need to occupy a volume smaller than one cubic inch. In order to fit into such small dimensions, various embodiments utilize mirrors to fold an optical path. A folded optical path decreases the necessary length of the microscope module with a certain focal length. For example, if the focal length of the microscope module is 3 inches, a module with a straight optical path must be at least 3 inches long. However, in a microscope module with a bent optical path utilizing two mirrors to bend the path orthogonally (i.e., in 90 degree angles) and equally positioned along the optical path, the module only needs to be at least one inch long.

Various embodiments of the invention are designed for use with modular user devices, for example, modular phones. For example, various embodiments of the invention are configured to fit into the PROJECT ARA® phone developed by GOOGLE®. In various embodiments, the modular phone has other detachable modules which are in signal communication with the microscope module. For example, the modular user device can have a detachable screen module which is a capacitive touch screen with a LED (light emitting diode) or OLED (organic light emitting diode) display, an expandable memory module (e.g., accepting a micro-SD card), a fingerprint reader module, a camera module, a BLUETOOTH® module, a speaker module, a Wi-Fi module, a GPS (i.e., global positioning system) module, and the like. In an embodiment where the modular user device is suited for medical use, other modules can include a microscope module, a stethoscope module, a blood sugar module monitor, a pulse oximetry module, an electrode-reading module (e.g., to measure an electrocardiogram, electromyogram, and electroencephalogram signal) and other medically suited modules. In some embodiments, the modular user device is a modular tablet, a modular smartwatch, or a modular wearable device (e.g., a pendant).

In summary, the illustrated embodiments of the invention include a microscope apparatus for use with a modular user device to image a specimen. The microscope apparatus includes a first processor for image processing, a camera sensor, communicated to the first processor, one or more data ports, wherein the one or more data ports are configured to transmit data from the camera sensor to the modular user device, a microscope lens, a plurality of mirrors, wherein the mirrors are operative to reflect an image from the microscope lens towards the camera sensor in a folded path to allow inclusion of the microscope apparatus with the modular user device, and wherein the camera sensor is fixedly positioned in relation to one or more or the plurality of mirrors, a stage, which is configured to load the specimen to be imaged, wherein the microscope lens is directed towards the stage in order to capture an image of the specimen, and an adjusting mechanism, wherein the adjusting mechanism adjusts the position of the stage in order to adjust an optical path distance between the stage and the microscope lens.

The adjusting mechanism is one of the group consisting of: a screw, a friction-based sliding adjuster, a sliding adjuster with a locking mechanism, or a cantilever.

In one embodiment the data ports transmit data from the camera sensor to a second processor through one of the group consisting of: a capacitive type coupling transmission mechanism, or an inductive type coupling transmission mechanism.

In another embodiment the data ports transmit data from the camera sensor to a second processor through a wired connection.

The microscope apparatus further includes a light source, wherein the light source is positioned in close proximity to the stage, wherein the light source is configured to illuminate the specimen.

The light source includes an objective lens ring which provides episcopic illumination; and a sub-stage light which provides diascopic illumination.

The lens is configured to provide magnification which is between 10× and 450×.

The microscope apparatus further includes a module casing, wherein the module casing is operative to cover the lens and the plurality of mirrors, and wherein the module casing further comprises one or more coupling mechanisms which are configured to removably fasten the module casing to the modular user device.

The module casing is equal to or smaller than 2.5 inch×4 inch×4 inch.

The plurality of mirrors is operative to reflect an image from the microscope lens towards the camera sensor in a folded path, by bending the image in a plurality of folds, where each of the plurality of folds is an orthogonal or near-orthogonal fold.

The microscope apparatus further includes a slide fastener configured to removably fasten a slide to the stage.

The scope of the illustrated embodiments also include a method for viewing a magnified image using a microscope module which includes the steps of illuminating a specimen on a stage, wherein the stage is within the microscope module, magnifying an image of the specimen using one or more lenses within the microscope module, transmitting the magnified image to a camera sensor, through a bent optical path, wherein the optical path is bent using one or more mirrors, transmitting the magnified image from the microscope module to one or more processors of a modular user device, through the use of one or more data ports, and displaying the magnified image on the screen of the modular device.

The method further includes the step of modifying the image within the microscope module, using one or more processors.

The method further includes the step of overlaying one or more of: the scale of the image and the resolution of the image, wherein the overlay is over the magnified image displayed on the screen of the modular user device.

The method further includes the step of overlaying a graphic describing the focus of the image over the magnified image displayed on the screen of the modular user device, wherein the graphic describes one or more of: the focal length, the optimal focus, and a sliding scale depicting the focus.

The method further includes the step of overlaying the resolution of the image over the magnified image displayed on the screen of the modular phone.

The method further includes the step of analyzing the image to identify medical data depicted within the image; and overlaying a description of the identified medical data over the magnified image.

The medical data is a cell count, and wherein the cell count is identified using image filtering techniques.

The step of magnifying the image of the specimen further includes magnifying the image between 10× and 450×.

The illustrated embodiments also include a computer-implemented system, the system which includes a processor; a server; and a memory storing instructions that, when executed by the processor, configure the system to: illuminate a specimen on a stage, wherein the stage is within the microscope module, magnify an image of the specimen using one or more lenses within the microscope module, transmit the magnified image to a camera sensor, through a nonlinear optical path, wherein the optical path is bent using one or more mirrors, transmit the magnified image from the microscope module to one or more processors of a modular user device, through the use of one or more data ports, and display the magnified image on the screen of the modular phone.

While the apparatus and method has or will be described for the sake of grammatical fluidity with functional explanations, it is to be expressly understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112 are to be accorded full statutory equivalents under 35 USC 112. The disclosure can be better visualized by turning now to the following drawings wherein like elements are referenced by like numerals.

### BRIEF DESCRIPTION OF THE DRAWINGS

FIG. 1 is an illustrative drawing depicting an example microscope module which is configured to fit into a modular user device.

FIG. 2 is an illustrative side cross sectional view depicting the inner components of an example microscope module.

FIGS. 3a and 3b are illustrative side cross sectional and perspective side cross sectional views respectively depicting example configurations of reflectors which bend an optical path within the microscope module.

FIG. 4 is an illustrative side cross sectional view depicting example configurations of reflectors which bend an optical path within the microscope module.

FIG. 5 is a flow diagram depicting an example method for displaying a magnified image using a modular microscope.

FIG. 6 is a flow diagram further explaining an example method to display a magnified image on the screen of a modular user device.

FIG. 7 is a flow diagram further explaining an example method to modify a magnified image using one or more processors.

FIG. 8 is an illustrative diagram depicting an example magnified image of a specimen using the microscope module.

FIG. 9 is an illustrative user interface diagram of the display of a magnified image of a specimen on the screen of a modular user device.

FIG. 10 is a high-level architectural diagram showing example functional parts within the microscope module and how they connect to the rest of the modular user device.

FIG. 11 is an illustrative block diagram depicting the connections between the microscope module, the modular user device, and third-party servers.

The disclosure and its various embodiments can now be better understood by turning to the following detailed description of the preferred embodiments which are presented as illustrated examples of the embodiments defined in the claims. It is expressly understood that the embodiments as defined by the claims may be broader than the illustrated embodiments described below.

### DETAILED DESCRIPTION OF THE PREFERRED EMBODIMENTS

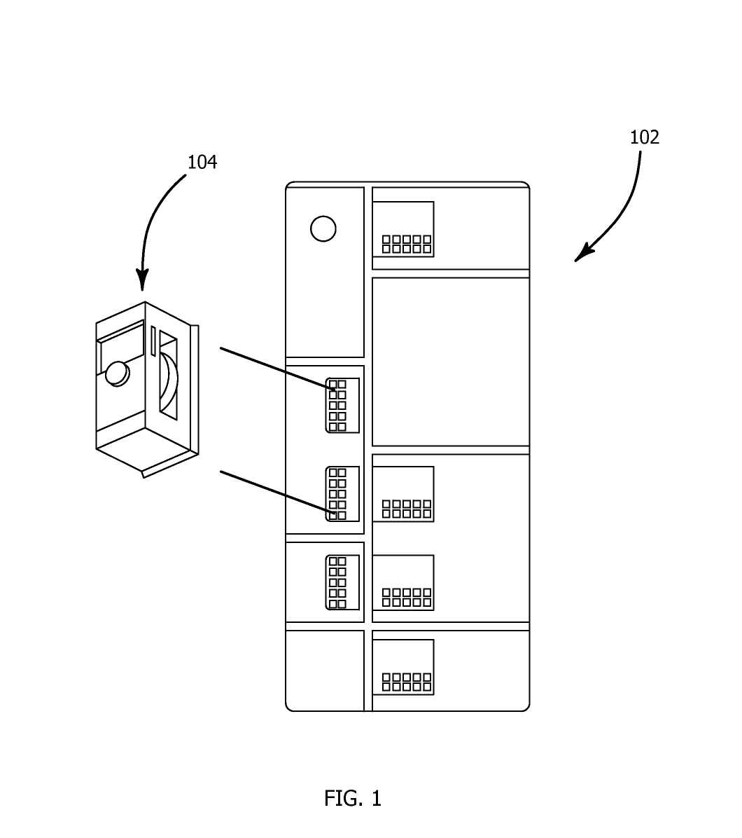

FIG. 1 is an illustrative drawing depicting the microscope module which is configured to fit into a modular user device. Microscope module 104 is removably attachable to modular user device 102 (i.e. a modular phone such as the PROJECT ARA® modular phone made by GOOGLE®). Microscope module 104 is designed, therefore, to fit into the dimensions of the modular device 102. For example, if a modular phone contains slots which fit various modules with dimensions of 1 inch by 1 inch by 2 inches, the microscope module must be housed in casing fitting within the dimensions of 1 inch by 1 inch by 2 inches. In another example where a modular tablet is created to use various modules with dimensions of 2 inches by 2 inches by 4 inches, the microscope module must be housed in casing fitting within the dimensions of 2 inches by 2 inches by 4 inches.

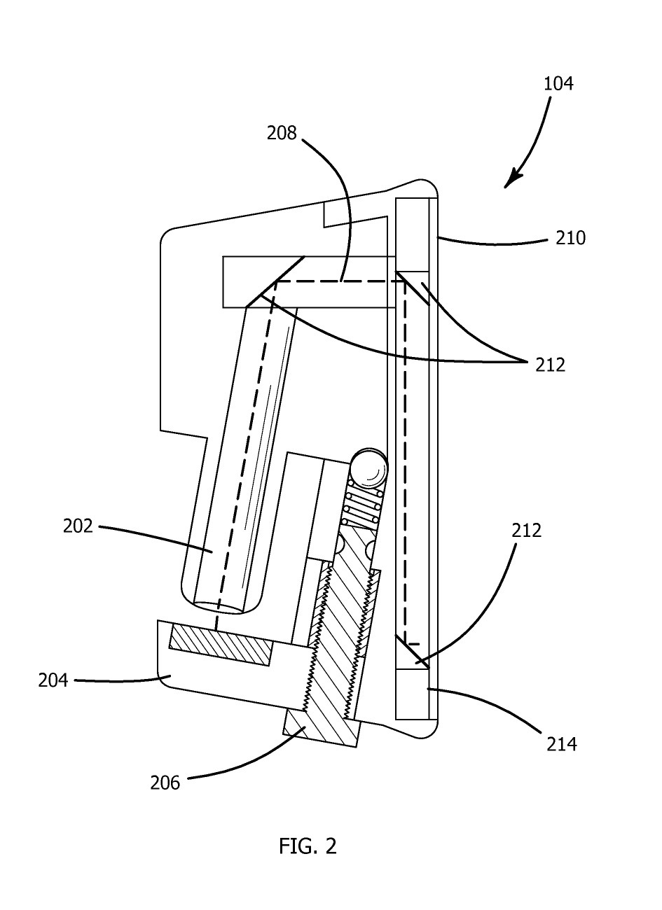

Referring now to FIG. 2, an illustrative diagram depicting an example microscope module 104 is depicted. The microscope module 104 contains a lens system 202, which is directed at a stage 204. Lens system 202 is operative to magnify and transmit optical data consisting of images through the microscope module. Lens system 202 may contain one or more optical lenses of varying magnification. For example, lens system 202 may contain one objective lens (e.g., a convex lens) providing 100× (i.e., 100 times) magnification. In another example embodiment, lens system 202 comprises multiple lenses in series, for example a 40× lens in series with a 10× convex lens. Other lens systems that may be used include achromat lenses, plan achromat lenses, fluorite lenses, plan fluorite lenses, and plan apochromat lenses. In various embodiments, lens system 202 comprises multiple lenses which can be mechanically moved into position. For example, lens system 202 contains multiple lenses, each lens having a different power to provide various levels of magnification. In the aforementioned example, a turret or slide is used to select a lens with a certain magnification, in order to alter the magnification of the microscope module 104. The optical lens or lenses within lens system 202 is made, in various embodiments, of polymeric materials (e.g., polycarbonate), glass, glass with additives, coated materials, etc. In some embodiments, lens system 202 is an oil immersion objective lens which requires immersion oil to form a bridge between the microscope slide and the lens system 202. In various embodiments, lens system 202 is comprised of one or more lenses contained within a barrel (e.g., a cylindrical tube or a square tube). The barrel is made, for example, out of a rigid polymeric material such as PVC (polyvinyl chloride), PP (polypropylene), PS (polystyrene), or ABS (acrylonitrile butadiene styrene) which is extrusion molded or injection molded.

In various example embodiments, stage 204 is operative to hold a specimen sample, from which a magnified image is created by the microscope module 104. Stage 204 is made of a rigid material on which a specimen can be loaded. For example, stage 204 is made of metal, wood, or a polymeric material such as PVC (polyvinyl chloride), PP (polypropylene), PS (polystyrene), or ABS (acrylonitrile butadiene styrene) which is extrusion molded or injection molded. Stage 204 contains space to store a specimen for magnification, and in some embodiments, contains a fastening mechanism to hold a specimen slide in place during the operation of the microscope module 104. For example, stage 204 contains a clip to hold the specimen slide in place or a slot which snugly holds the specimen slide in place during operation.

Stage 204 contains a focus adjust 206, which is operative to move the stage and alter the distance of the optical path 208 within the microscope module 104. In some embodiments, the focus adjust is a threaded screw attached to a knob which alters the position of the screw, moving the stage 204 to increase or decrease the distance of the optical path 208. In other embodiments, the focus adjust 206 uses a friction slide to adjust the position of the stage. The focus adjust 206 is attached to the stage in some embodiments molded in the same piece as the stage 204 in some embodiments, welded to the stage 204 in some embodiments, and a separate piece from stage 204 in some embodiments.

The focus adjust 206 allows for movement of the stage 204. In various embodiments, the focus adjust allows for movement of the stage 204 perpendicular to the optical path 208 where the optical path 208 meets the stage 204. Light is transmitted along the optical path 208, transmitting an image from stage 204 through lens system 202 to camera sensor 214. In some embodiments, there is a light source behind the area in stage 204 where the specimen sample is loaded, in order to transmit light through lens system 202 so that the camera sensor 214 measures an image of the specimen. For example, a light source (e.g., an LED or a laser) is pointed at lens 202 and transmits light through a condenser lens as well as through the specimen before reaching lens system 202. In some embodiments, a light source facing away from lens system 202 and towards the sample loaded onto stage 204 is reflected back through lens 202 so that a magnified image is sensed by the camera sensor 214.

Between lens system 202 and camera sensor 214, the optical path 208 is bent by one or more reflectors 212. In some embodiments, reflectors 212 are mirrors. In other embodiments, reflectors 212 are prisms. In yet other embodiments, a combination of mirrors and prisms are used. Through the use of reflectors 212, the optical path 208 is bent allowing for a compact module. For example, if the optical path is 12 centimeters long and has reflectors 212 comprising two mirrors which bend the optical path into three segments of equal length, the optical path can fit into a module which is slightly larger than 4 cm×4 cm, rather than requiring a module which is at least 12 cm in length. In various embodiments, reflectors 212 bend the optical path orthogonally (i.e., in a 90 degree angle) or non-orthogonally.

The magnified image of the specimen is sensed by the camera sensor 214 which is attached to a circuit board 210. The camera sensor is, for example, a complementary metal-oxide semiconductor (CMOS), a semiconductor charge-coupled device (CCD), or an N-type metal-oxide semiconductor (NMOS, Live MOS) sensor. The camera sensor 214 is attached to the circuit board 210 and transmits image data to one or more processors. The raw image data is processed within the camera sensor 214 in some embodiments, and by the one or more processors in other embodiments. For example, the image data is processed by a processor within the microscope module which is also attached to the circuit board 210.

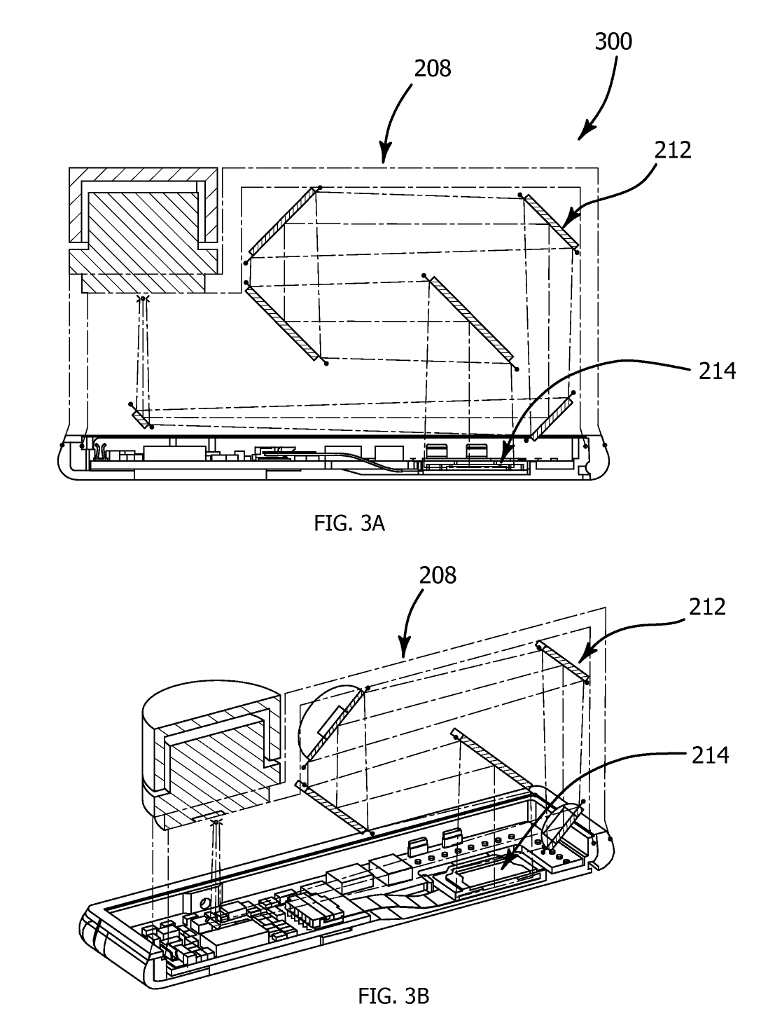

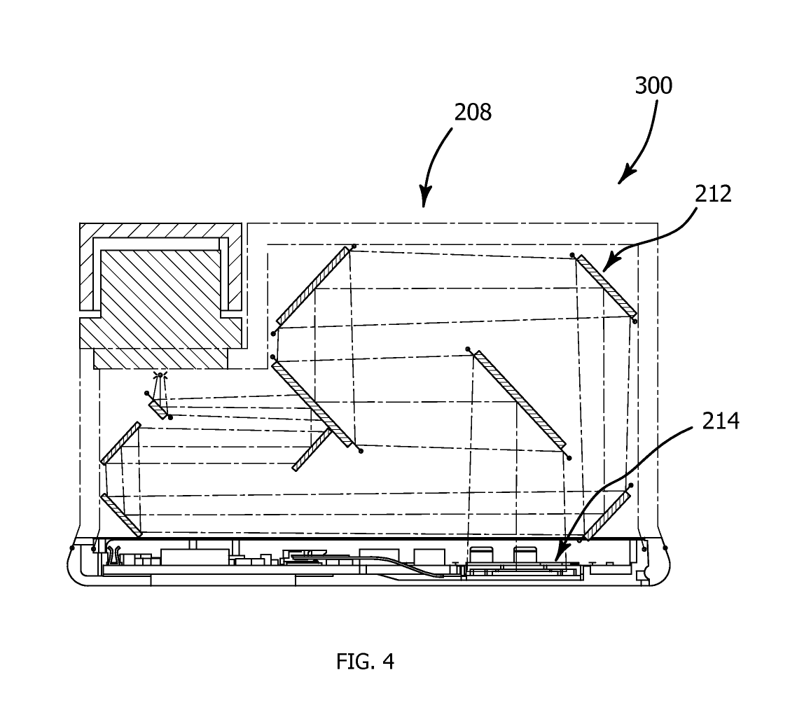

FIGS. 3a, 3b and 4 are illustrative diagrams depicting how reflector(s) 212 bend the optical path 208 within the microscope module 104 before ultimately directing the image to camera sensor 214. Thus, the microscope module can house an optical path 208 with a much longer distance than the dimensions of the microscope module 104. As stated in FIG. 2, reflector(s) 212 are mirrors in some embodiments, and prisms in some embodiments. Reflector(s) 212 bend light orthogonally (i.e., in a 90-degree or near-90 degree angle, for example between 88 and 92 degrees) or non-orthogonally (e.g., in a 20-degree angle) in order to condense the optical signal which travels through optical path 208 before reaching camera sensor 214. In FIGS. 3a and 3b, an arrangement of reflectors 212 is depicted with six reflectors, which lengthen the optical path 208 before the optical path 208 is reflected towards the camera sensor 214. In FIG. 4, an arrangement is shown containing nine reflectors, providing an even longer optical path 208. In example embodiments, therefore, the use of reflectors to bend the optical path allows for an optical path 208 which is between 100 millimeters and 150 millimeters in length, which fits into a module which is 25.4 millimeters by 25.4 millimeters by 50.8 millimeters in dimension. In various embodiments, the reflectors 212 bend the image in a plurality of bends, where every bend is orthogonal or near-orthogonal (e.g., between 88.5 and 90.5 degrees).

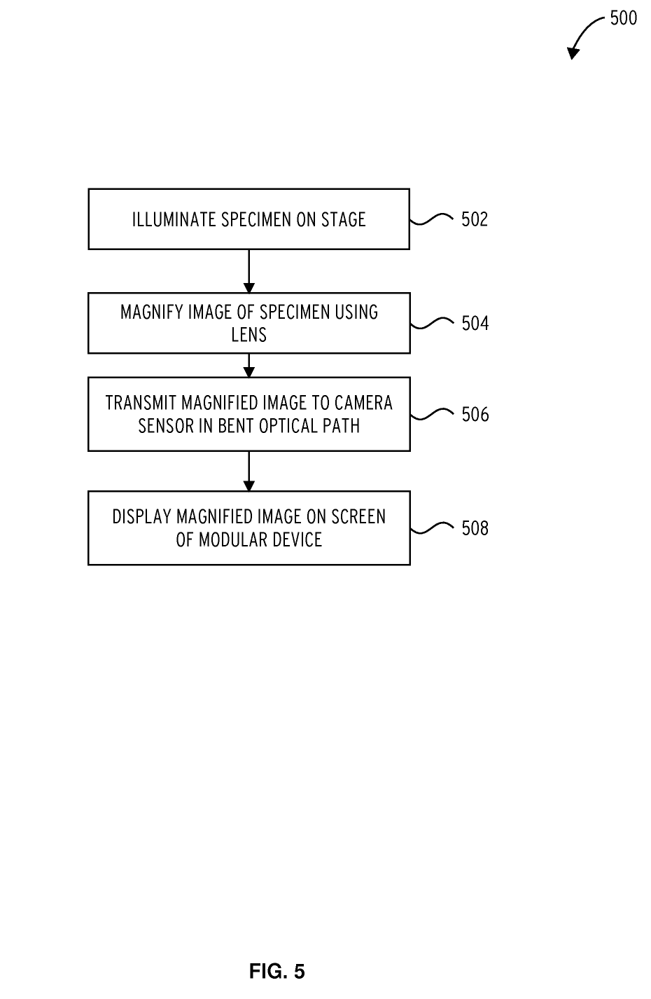

Turning now to FIG. 5, a flow diagram illustrating a method for displaying a magnified image using a modular microscope 500 is depicted. At step 502, the system illuminates a specimen on stage 204. For example, the microscope module 104 uses LED lights, halogen lights, or fiber optic lighting in order to illuminate the specimen. At step 504, the illuminated specimen's image is magnified using a lens (i.e., lens system 202 as described in FIG. 2). For example, the specimen is magnified at between 10× and 300× magnification. In some embodiments, the lens system 202 provides a fixed magnification. In other embodiments, the lens system 202 provides variable magnification. At step 506, the magnified image of the specimen is transmitted to the camera sensor 214 in a bent optical path. As described in FIG. 2, the optical path 208 is bent using one or more reflectors (e.g., mirrors or prisms). Once the magnified image reaches the camera sensor 214 in step 506, the magnified image is displayed on the screen of a modular user device in step 508. For example, the camera sensor 214 is connected to a circuit board 210, which is connected to data ports allowing for a wired data connection between the microscope module 104 and the modular user device 102 (e.g., a modular phone). In another example, the microscope module connects with the modular user device 102 wirelessly, for example using Wi-Fi or BLUETOOTH®.

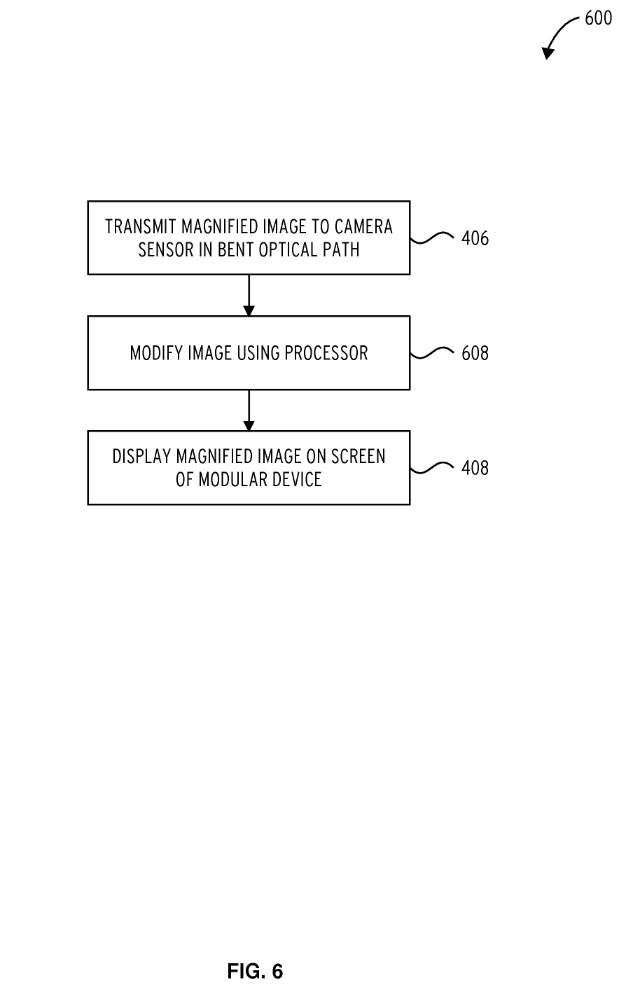

FIG. 6 depicts, in further detail, a flow diagram 600 describing how the magnified image is displayed on the screen of the modular user device (see FIG. 5 for a more detailed description of step 508). Once the magnified image is transmitted to the camera sensor 214 in a bent optical path, as described in step 506 of FIG. 5, the image is modified using one or more processors in step 608. In various embodiments, the microscope module contains one or more processors which are connected to circuit board 210. In such embodiments, the image is modified using one or more processors within the microscope module. Furthermore, processors within the camera sensor 214 (e.g., a CMOS sensor) modify the image in some embodiments. For example, in step 608, the image contrast, saturation, hue, sharpness, or exposure is modified by one or more processors. In various embodiments, filters including high-pass filters, low-pass filters, or Gaussian blur filters are used to modify the image, making the image easier to view on the screen of the modular device. Once the image has been modified, the magnified image is displayed on the screen of the modular user device in step 508.

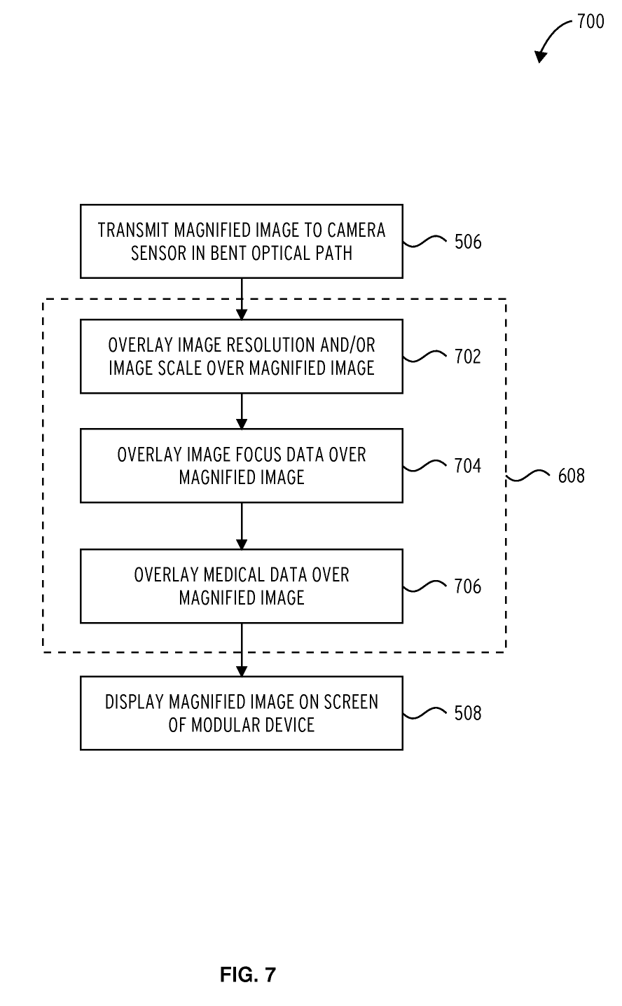

FIG. 7 is a flow diagram 700, depicting in more detail how the microscope module 104 modifies the magnified image using one or more processors. In step 506, as described in FIG. 5, the microscope module 104 transmits a magnified image to the camera sensor 214 using a bent optical path. Example steps 702, 704, and 706 depict numerous ways in which the image is modified using one or more processors in step 608 (described in more detail in FIG. 6). In step 702, one or more processors are used to overlay image resolution (or in some embodiments, image scale) over the magnified image. For example, image resolution is determined based on the magnification power of the lens system 202. For an embodiment with a fixed magnification power (e.g., 50×) and a fixed image scale, one or more processors overlays text depicting the image scale (e.g., 50 micrometers), or an image depicting the scale, over the magnified image. For an embodiment with variable magnification (e.g., between 10× and 300× magnification using a zoom lens), the microscope module controls the magnification power of the lens via one or more processors, displaying text describing the current magnification power overlaid over the magnified image. In step 704, the processor determines the position of the specimen stage (for example, based on determining the position of the focus adjust 206) and uses the focus data to overlay image focus data over the magnified image. For example, the processor generates a graphic which depicts the entire focal range as a polygon (e.g., a rectangle) with a line moving to the left as the slide is moved away from the lens, and the line moving to the right as the slide is moved towards the lens using the focus adjust 206. In step 706, the processor overlays medical data over the magnified image. The medical data may change based on the specimen being viewed. In various embodiments, a user selects a “mode” which determines the processing methods used based on the specimen a user is viewing—for example, modes include a blood cell count mode, bacteria count mode, a sickle cell recognition mode, parasite recognition mode, and the like. In other embodiments, the one or more processors automatically determine what is being viewed and overlay medical data based on the automatic image recognition in step 706. In an embodiment where the magnified image is of blood and the medical data mode is a blood cell count mode, the processor uses image modification techniques such as high pass filtering to identify cell shapes and count them. Based on the size and shape of each item recognized through the filtering method, the processor determines the number of each type of blood cell and overlays this data as text over the enlarged image. In some embodiments, step 706 involves identifying, counting, and displaying the number of red blood cells, white blood cells, and platelets within the image.

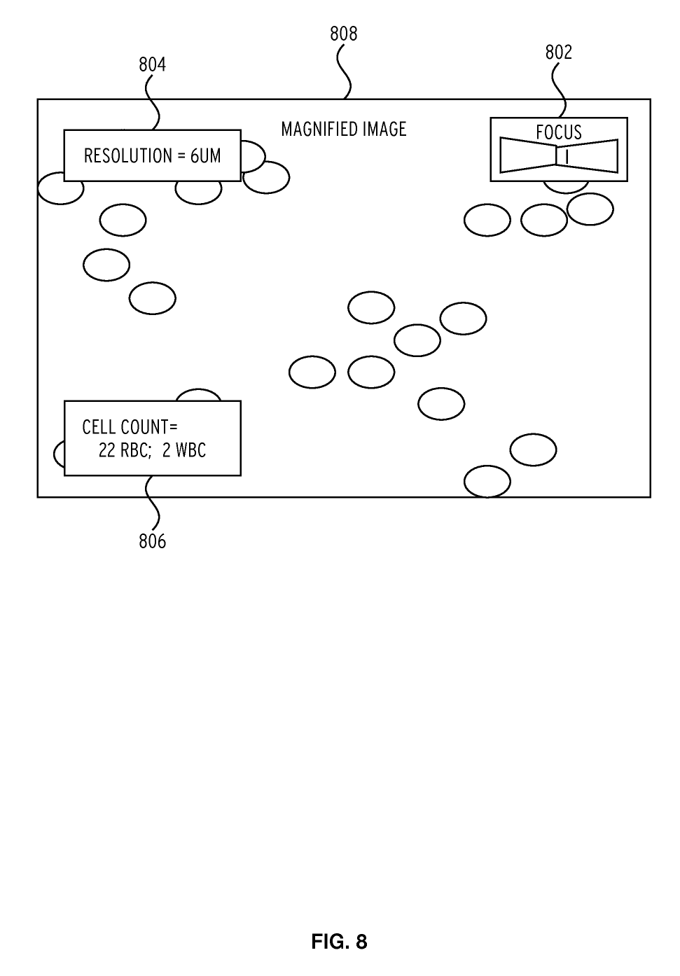

Referring now to FIG. 8, an illustrative diagram depicting an example magnified image 808 is shown. A magnified image such as the example magnified image 808 is displayed on the screen of a modular user device in step 508, described in more detail in FIG. 5. As depicted in FIG. 8, the magnified image is an image of blood cells. In the top left corner, the resolution (e.g., 6 micrometers) is displayed as described in step 702 of FIG. 7. In the top right corner, an image 802 depicting the focus of the microscope module is shown, with a vertical line depicting the current focus of the image. On the bottom left, medical data 806 is displayed as described in step 706 of FIG. 7. In the current example magnified image 808, the medical data is a cell count showing that there are 22 red blood cells and 2 white blood cells in the image, based on image filtering techniques.

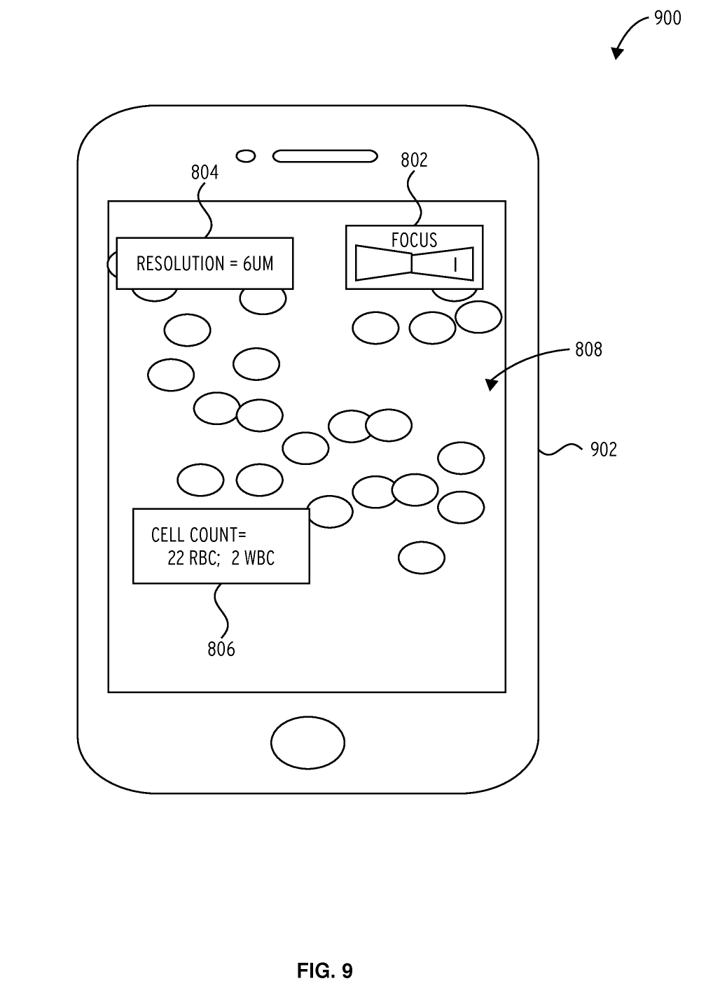

FIG. 9 is an illustrative user interface diagram 900 depicting the display of the magnified image as well as the data overlays of resolution 804, medical data 806, and focus 802 shown over the magnified image 808. In FIG. 9, the magnified image is displayed on the screen of a modular user device 102. For example, the modular device is a modular smartphone (e.g., the PROJECT ARA® device by GOOGLE®) and the screen is a separate module. In some embodiments, the modular user device 102 also contains connectivity modules, allowing for wireless connection (e.g., Wi-Fi, NFC, 3G, 4G, LTE, or BLUETOOTH®) to send the magnified image 808 from the modular user device 102 to another device wirelessly. In various embodiments, the microscope module 104 uses the cellular communications functionality of the modular user device 102 (e.g., a smartphone) to communicate with other devices.

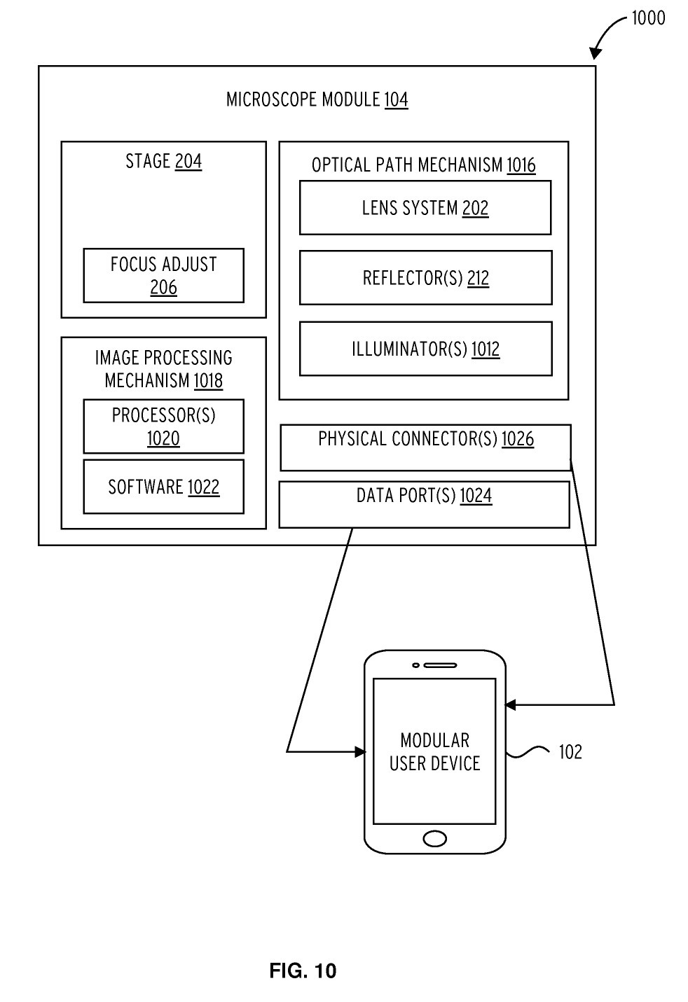

Referring now to FIG. 10, a high-level architecture diagram 1000 showing example functional parts within the microscope module 104 and how they connect to the rest of the modular user device 102 is depicted. Stage 204 is operative to hold a sample specimen in place for image magnification, and comprises an adjusting mechanism 206 which adjusts the position of the stage 204 and provides proper focus within the magnified image. The optical path mechanism 208 contains lens(es) 202, reflectors 212 (e.g., mirrors or prisms), and in some embodiments, illuminator(s) 1012 to provide illumination of the specimen. Microscope module 104 also contains an image processing mechanism 1018, comprising one or more processor(s) 1020 as well as software 1022. Processor(s) 1020, in various embodiments, run software 1022 in order to modify the magnified images. To physically connect to the modular user device 102, the microscope module contains one or more physical connectors 1026. In some embodiments, physical connectors 1026 are latches. In various other embodiments, physical connectors 1026 are latches, screws, magnets, or adhesive strips. Furthermore, the microscope module 104 can transmit and receive data from the modular user device 102 through the use of data port(s) 1024. In some embodiments, data ports 1024 are capacitive data ports. In other embodiments, data ports 1024 are wired data ports. In yet other embodiments, data ports 1024 are inductively coupled data ports. The data ports 1024 can also, in some embodiments, be wireless connections to the modular user device 102 such as Wi-Fi or BLUETOOTH®.

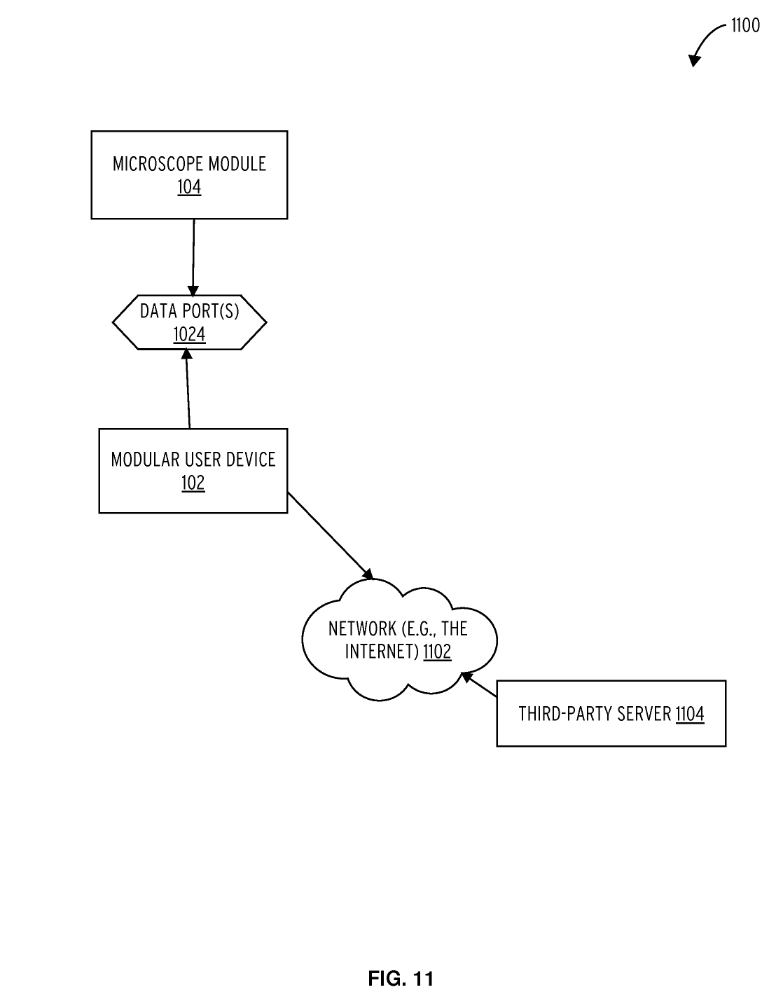

FIG. 11 is an illustrative diagram depicting, at a high level, the connections between the microscope module 104, the modular user device 102, and third-party server(s) 1104. As described in FIG. 10, the microscope module 104 and the modular user device 102 are connected through data port(s) 1024 (e.g., inductive data ports, capacitive data ports or wired data ports). In various embodiments, the modular user device 102 is connected to one or more third-party server(s) 1104 through the use of a network (e.g., the Internet) 1102. The modular user device 102 and third-party server 1104 are therefore in signal communication in various embodiments, allowing for magnified image data from the microscope module 104 to be transmitted to other devices. For example, a microscope module 104 is used to detect malaria in Ghana. Through the network communication 1102, the magnified image from the microscope module 104 in Ghana is sent to a research lab computer in Los Angeles, Calif., for analysis.

Many alterations and modifications may be made by those having ordinary skill in the art without departing from the spirit and scope of the embodiments. Therefore, it must be understood that the illustrated embodiment has been set forth only for the purposes of example and that it should not be taken as limiting the embodiments as defined by the following embodiments and its various embodiments.

Therefore, it must be understood that the illustrated embodiment has been set forth only for the purposes of example and that it should not be taken as limiting the embodiments as defined by the following claims. For example, notwithstanding the fact that the elements of a claim are set forth below in a certain combination, it must be expressly understood that the embodiments includes other combinations of fewer, more or different elements, which are disclosed in above even when not initially claimed in such combinations. A teaching that two elements are combined in a claimed combination is further to be understood as also allowing for a claimed combination in which the two elements are not combined with each other, but may be used alone or combined in other combinations. The excision of any disclosed element of the embodiments is explicitly contemplated as within the scope of the embodiments.

The words used in this specification to describe the various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptionally equivalent, what can be obviously substituted and also what essentially incorporates the essential idea of the embodiments.

What is claimed is:

1. A microscope apparatus for use with a modular user device to image a specimen, comprising:
a first processor for image processing;
a camera sensor, communicated to the first processor;
one or more data ports, wherein the one or more data ports are configured to transmit data from the camera sensor to the modular user device;
a microscope lens;
a plurality of mirrors, wherein the mirrors are operative to reflect an image from the microscope lens towards the camera sensor in a folded path to allow inclusion of the microscope apparatus with the modular user device, and wherein the camera sensor is fixedly positioned in relation to one or more or the plurality of mirrors;
a stage, which is configured to load the specimen to be imaged, wherein the microscope lens is directed towards the stage in order to capture an image of the specimen; and
an adjusting mechanism, wherein the adjusting mechanism adjusts the position of the stage in order to adjust an optical path distance between the stage and the microscope lens.

2. The microscope apparatus of claim 1, wherein the adjusting mechanism is one of the group consisting of: a screw, a friction-based sliding adjuster, a sliding adjuster with a locking mechanism, or a cantilever.

3. The microscope apparatus of claim 1, wherein the data ports transmit data from the camera sensor to a second processor through one of the group consisting of: a capacitive type coupling transmission mechanism, or an inductive type coupling transmission mechanism.

4. The microscope apparatus of claim 1, wherein the data ports transmit data from the camera sensor to a second processor through a wired connection.

5. The microscope apparatus of claim 1, further comprising:
a light source, wherein the light source is positioned in close proximity to the stage, wherein the light source is configured to illuminate the specimen.

6. The microscope apparatus of claim 5, wherein the light source comprises:
an objective lens ring which provides episcopic illumination; and
a sub-stage light which provides diascopic illumination.

7. The microscope apparatus of claim 1, wherein the lens is configured to provide magnification which is between 10× and 450×.

8. The microscope apparatus of claim 1, further comprising:
a module casing, wherein the module casing is operative to cover the lens and the plurality of mirrors, and wherein the module casing further comprises one or more coupling mechanisms which are configured to removably fasten the module casing to the modular user device.

9. The microscope apparatus of claim 8, wherein the module casing is equal to or smaller than 2.5 inch×4 inch×4 inch.

10. The microscope apparatus of claim 8, wherein the plurality of mirrors is operative to reflect an image from the microscope lens towards the camera sensor in a folded path, by bending the image in a plurality of orthogonal or near-orthogonal folds.

11. The microscope apparatus of claim 1, further comprising:
a slide fastener configured to removably fasten a slide to the stage.

12. A method for viewing a magnified image using a microscope module, comprising:
illuminating a specimen on a stage, wherein the stage is within the microscope module;
magnifying an image of the specimen using one or more lenses within the microscope module;
transmitting the magnified image to a camera sensor, through a bent optical path, wherein the optical path is bent using one or more mirrors;
transmitting the magnified image from the microscope module to one or more processors of a modular user device, through the use of one or more data ports; and
displaying the magnified image on the screen of the modular device.

13. The method of claim 12, further comprising:
modifying the image within the microscope module, using one or more processors.

14. The method of claim 12, further comprising:
overlaying one or more of: the scale of the image and the resolution of the image,
wherein the overlay is over the magnified image displayed on the screen of the modular user device.

15. The method of claim 12, further comprising:
overlaying a graphic describing the focus of the image over the magnified image displayed on the screen of the modular user device,
wherein the graphic describes one or more of: the focal length, the optimal focus, and a sliding scale depicting the focus.

16. The method of claim 12, further comprising:
overlaying the resolution of the image over the magnified image displayed on the screen of the modular phone.

17. The method of claim 12, further comprising:
analyzing the image to identify medical data depicted within the image; and
overlaying a description of the identified medical data over the magnified image.

18. The method of claim 17, wherein the medical data is a cell count, and wherein the cell count is identified using image filtering techniques.

19. The method of claim 12, wherein the magnifying the image of the specimen further comprises magnifying the image between 100× and 450×.

20. A computer-implemented system, the system comprising:
a processor;
a server; and
a memory storing instructions that, when executed by the processor, configure the system to:
illuminate a specimen on a stage, wherein the stage is within the microscope module;
magnify an image of the specimen using one or more lenses within the microscope module;
transmit the magnified image to a camera sensor, through a nonlinear optical path, wherein the optical path is bent using one or more mirrors;
transmit the magnified image from the microscope module to one or more processors of a modular user device, through the use of one or more data ports; and
display the magnified image on the screen of the modular phone.
